(19) United States
(12) Patent Application Publication
(10) Pub. No.: US 2005/0107130 A1
(43) Pub. Date: May 19, 2005

(54) Telephone silent conversing (TSC) system

(76) Inventor: William Donald Peterson II, Salt Lake City, UT (US)

Correspondence Address: William Donald Peterson II, 68 West Malvern Ave, Salt Lake City, UT, 84115, US

(21) Appl. No.: 10/987,465

(22) Filed: Nov. 13, 2004

Related U.S. Application Data
(60) Provisional application No. 60/519,896, filed on Nov. 14, 2003.

(51) Int. Cl. H04M 1/64

(52) U.S. Cl. 455/567; 455/569.1; 455/569.2; 379/67.1

(57) ABSTRACT

A new type of telephone device is made such to answer an incoming call, the incoming message is listened to but the answerer stays silent and instead replies with a recorded prepared message, the conversation continues this way, with means for the receiving party to be silent and unobtrusive amongst others. In addition to having prepared answers and messages, the correspondent can make other messages. A call out is made the same way, the caller remaining silent and inconspicuous. The new telephone device has the outward appearance of only a hearing aid worn on a user. A combination of a cellular telephone and a hearing aid components are such that when the combination instrument is not functioning as a cellular phone (calling, ringing, talking, listening), the combination instrument is functioning as a hearing aid for the user's (personal conversing), where the external ambient sound, including voice from persons talking to the user is collected by the cellular telephone microphone (Mic.), or hearing aid Mic., or other or more, then the input is amplified, the input digitally adjusted by the hearing aid for the users hearing frequency deficiencies, then transmitted to an earpiece speaker[s] in place in the users ear[s], one or both. Sound collected in two mics would enable stereo listening for the user. Then when a phone call occurs, the phone system received sound is collected and carried to the same speaker[s] in place in the users ears. As an additional benefit received audio from persons calling is (like personal conversing) adjusted for the instrument's user's hearing frequency deficiencies so he hears the callers voice in correct perspective. A system of switching to transition between phone and hearing aid function, using automatic phone sensing to make such a switch, or having a switch at the phone, or having a switch at the phone cord. The device also being combined with other audio devices, including a Mic. for normal cell phone function.

### BACKGROUND OF THE INVENTION

For more than a half century hearing has been aided by an electronic amplifier where sound is received, modified to amplify sound frequency ranges where a person is hearing deficient, then the amplified sound is played through a small speaker in the person's ear. For twice this time, for a century, people have been communicating over unlimited distances by telephone where head sets vary but always have a speaker communicating with the users ear[s] and microphone to pick up the users voice output. The head set most typically being in a one-hand held unit, but also being in head-attached cap like held hearing piece and boom mic., and also put in stand alone desk top units which all persons in a room can simultaneously communicate by. More recently, telephones have become highly mobile in the form of cellular telephones having the power, transmitter, receiver, and microphone combined into one-hand held module. This is sometimes modified with a simplified head set, an ear piece speaker and cord mounted Mic., the wiring going on to the Cell phone which can then be worn in a pocket or on the users belt. or clipped or pinned to other apparel. However, in this configuration telephone devices are becoming ever more interruptive where persons are attending meetings and in presence of others where incoming calls are interruptive with everyone about. Instead, incoming calls can be detected with cell telephones equipped with a vibrator. But still a person vocally answering to calling party is interruptive, he can't avoid when he talks back, his voice is interruptive to others around him. But, if he answered silently, if he answerer with a selected prerecorded messages, having means to access them, he can play back what he wants to say and correspond with the caller.

It is not unusual for persons to wear and use a hearing aid device. By combining a Telephone Silent Messaging (TSM) system, making it part of a hearing aid system, on a user, from the perspective of others, the user appears to only be using a hearing aid, where switching can be done automatically or coyly in the users pocket, under clothing, or on the clothing surface, so telephone conversations can happen without being obstructive to the local immediate surrounding dialog.

### STATEMENT OF THE ART

In time, a person may lose partial hearing. This impairment or loss might be only the loss some frequency ranges, like the higher frequencies. To repair the hearing for a person having such a loss what is likely needed may be selected frequency range magnification to bring hearing into a flat curve and range. New digital hearing instruments can apparently do this. So it may make sense to be using a hearing aid. But then, a hearing aid is not cool, i.e. not in style, not fashionable. So another question is how to adjust to having the hearing aid and how a person will appear with it. Normally, a hearing aid instrument is worn behind the ear, and smaller instruments can be worn in the ear.

In contrast, it is popular, and it is fashionable to carry and use a Cellular phone. Usually, a cellular phone is carried in a pocket or purse or in a case or pouch affixed to the users belt. It is convenient to have the Cellular phone in a shirt pocket or hanging on his belt and then have a small cord leading to a small speaker placed in an ear. A small microphone on the cord hangs alongside users mouth and works well to hold a mouth piece speaker microphone leading to the cellular telephone.

So, why not combine the two functions? Most everyone now wants and uses a cellular telephone, and many cel phone users need a hearing aid. Using a cellular phone is cool, using a hearing aid in conjunction with a cellular telephone would still be cool. So if such a device were available, possibly many people who need hearing assistance would use the combination hearing aid cellular telephone instrument, which would otherwise not use a hearing enhancer.

Then there are the all those people using cellular telephones who attend meetings constantly interrupted by someone's receiving a telephone call. Instead of the interruption, persons there could receive calls and correspond silently. Everyone would be better off and more comfortable.

### BRIEF SUMMARY OF THE INVENTION

Three functions are combined, a cellular telephone, a recorder player, and hearing aid. For someone attending meetings, hearing aid volume can be turned up to hear a speaker, and phone calls can be taken, or made, discretely without disrupting others. A new type of telephone device is made such to function with a hearing aid, work a cellular telephone, and to do telephone silent correspondence by answering incoming call with message saying “I am listening, and will response, so please talk to me” A selected message is played back, and the conversation continues thusly back and forth and is completed or continued.

An incoming phone call (also outgoing) does not disturb others in the proximity. An incoming message is listened to but the answerer stays silent and instead replies with a recorded prepared message, the conversation continues this way, with means for the receiving party to be silent and unobtrusive amongst others. In addition to having prepared answers and messages, the correspondent can make other messages. A call out is made the same way, the caller remaining silent and inconspicuous.

The new telephone device has the outward appearance of only a hearing aid worn on a user. A combination of a cellular telephone and a hearing aid components are such that when the combination instrument is not functioning as a cellular phone (calling, ringing, talking, listening), the combination instrument is functioning as a hearing aid for the user's (personal conversing), where the external ambient sound, including voice from persons talking to the user is collected by the cellular telephone microphone (Mic.), or hearing aid Mic., or other or more, then the input is amplified, the input digitally adjusted by the hearing aid for the users hearing frequency deficiencies, then transmitted to an earpiece speaker[s] in place in the users ear[s], one or both. Sound collected in two microphones would enable stereo listening for the user. Then when a phone call occurs, the phone system received sound is collected and carried to the same speaker[s] in place in the users ears. As an additional benefit, received audio from persons calling is (like personal conversing) adjusted for the instrument user's hearing frequency deficiencies so he hears the caller's voice in correct perspective. A system of switching to transition between phone and hearing aid function, using automatic phone sensing to make such a switch, or having a switch at the phone, or having a switch at the phone cord. The device also being combined with other audio devices, including a Mic. for normal cell phone function.

With appropriate switching, the TSC system could be set up so a user could switch back and forth from CelTel use or local sound amplification (hearing aid function) or both. Where mobility is not required, a conventional hard wired telephone works for the cellular phone.

### BRIEF DESCRIPTION OF DRAWINGS

FIG. 1 shows the combination of hearing aid with a cellular telephone configured on a user relative to a telephone call correspondent and nearby vocal voice correspondent.

FIG. 2 shows components of just the phone and companion hearing aid gear. A cellular phone is shown but the system could be a regular telephone and the hearing aid component could be head set mounted, for fixed station use. Audio frequency enhancement normal only to a hearing aid is thus achieved also for a telephone and any instrument proving audio. The Audio frequency enhancement would be based upon test of the users hearing for hearing losses. The hearing instrument can be computer adjusted by an audio technician or possibly by a user operated program. The cell phone would have enhanced features of having recordings and play back of the recordings. Connectors makes the phone easily separated. Sound enhancement enables hearing instrument modifications of phone reception to modify selective frequency ranges so a user hears telephone conversations in a way considered normal. This feature is normally only in a hearing aid instrument. A switch can be provided so the user can select unmodified phone hearing or frequency enhanced hearing.

FIG. 3, shows unit in more detail.

FIG. 4-16, drawings 1-12, shows connecting and switching options.

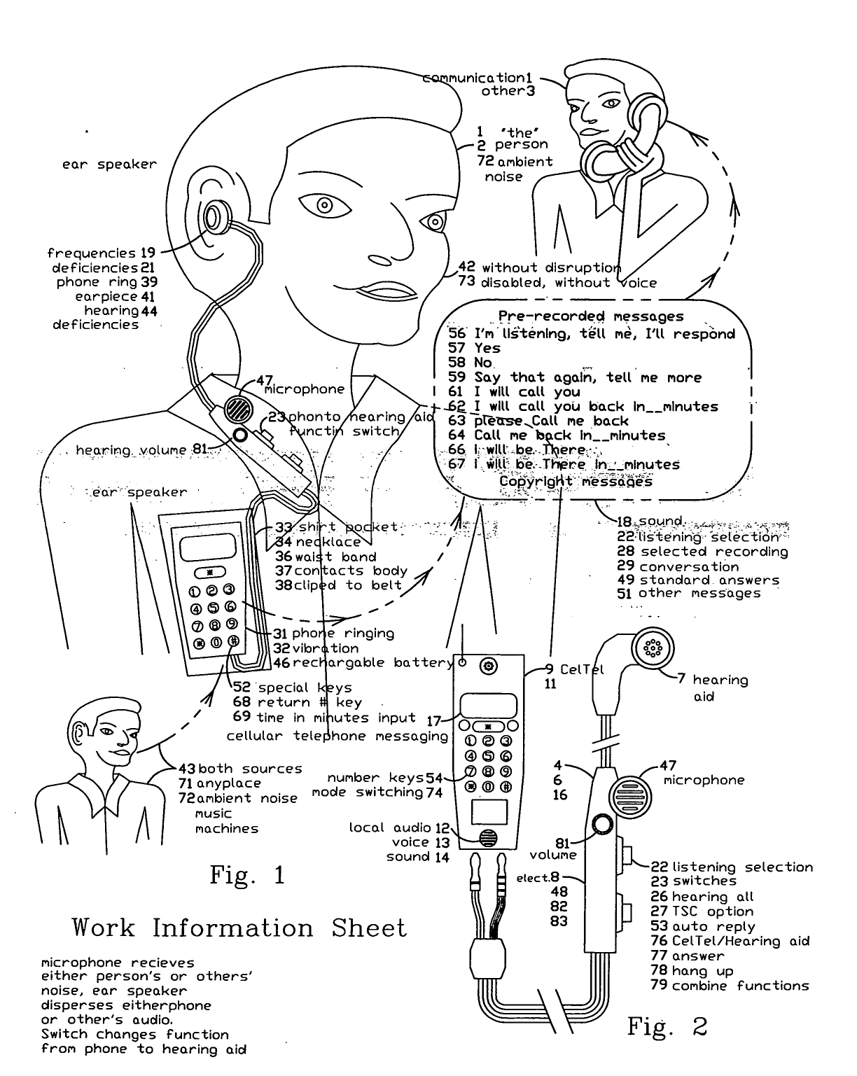

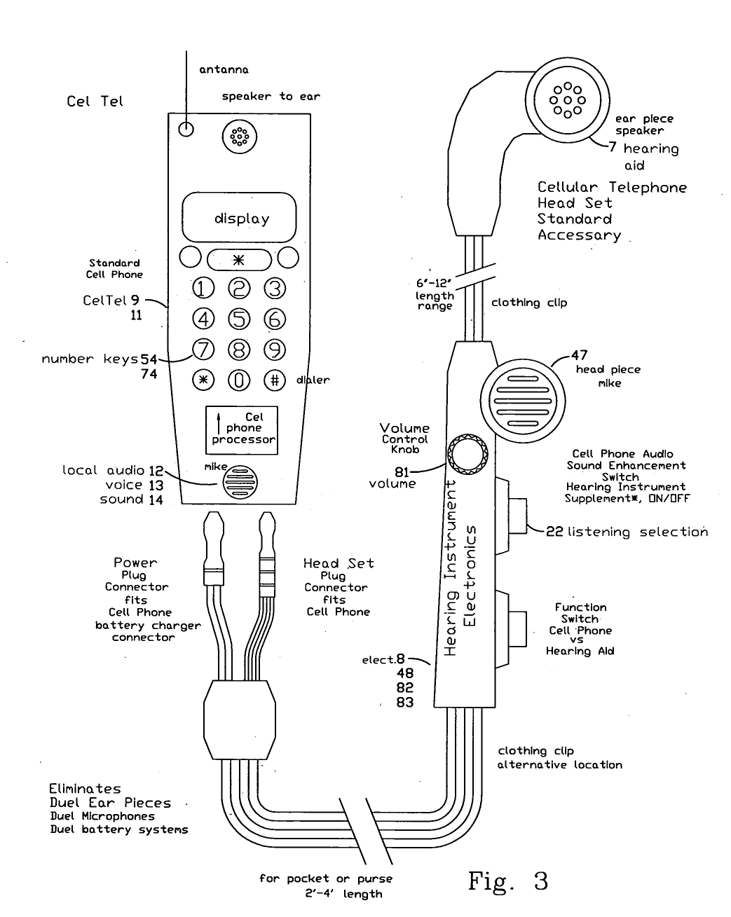

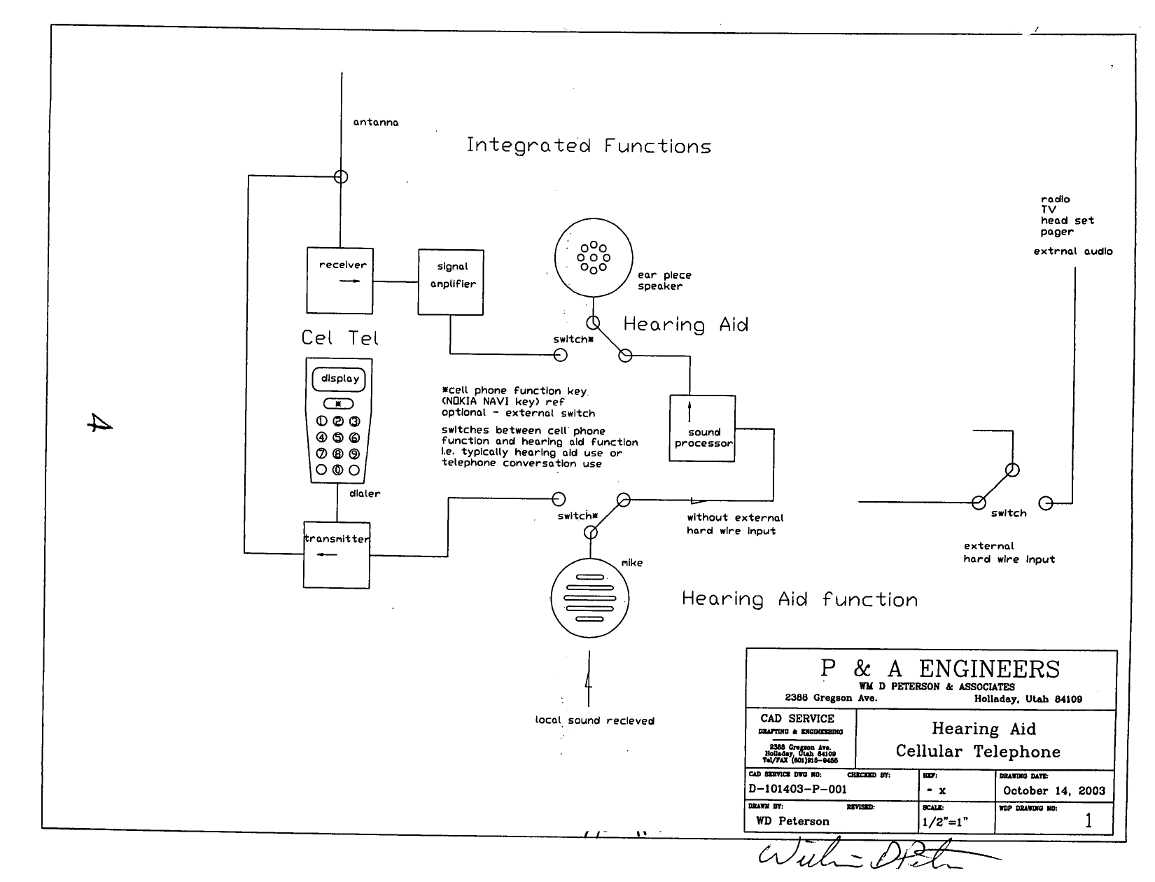

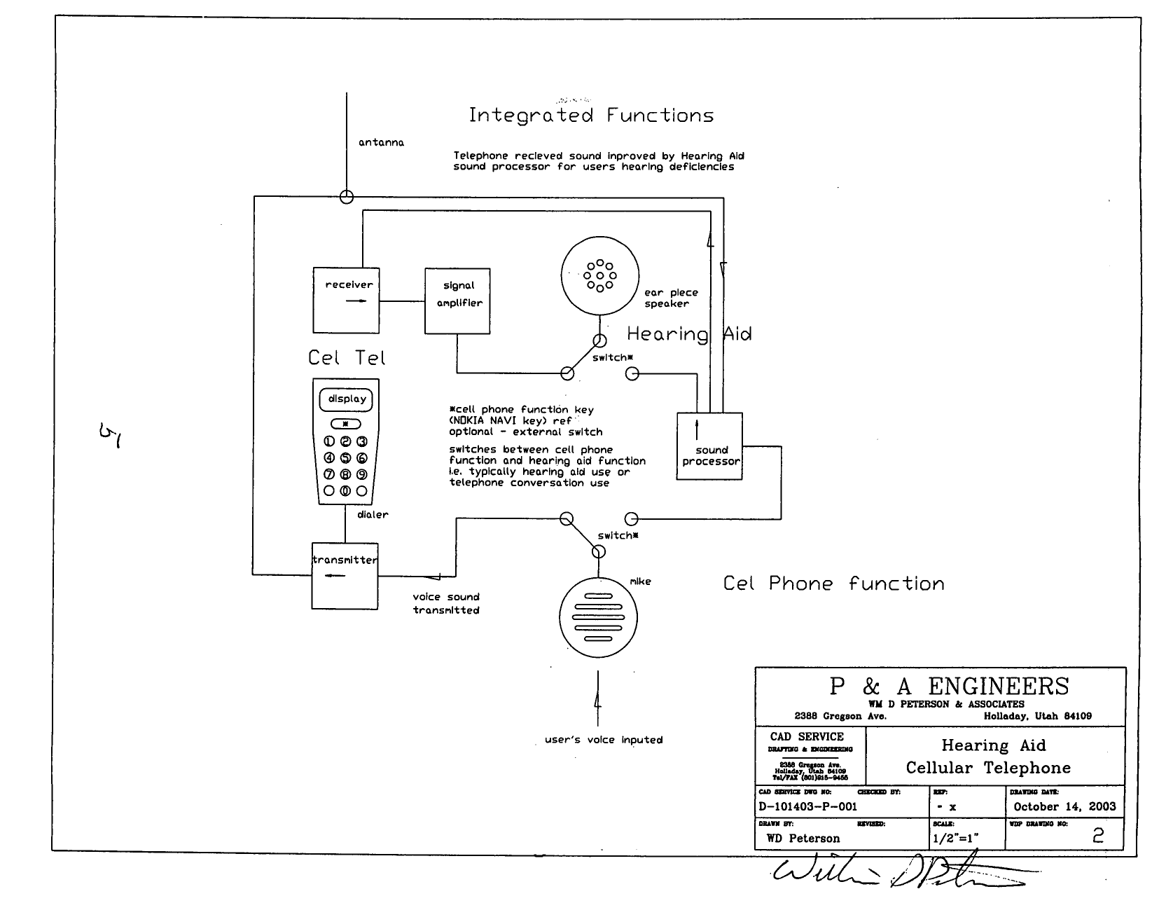

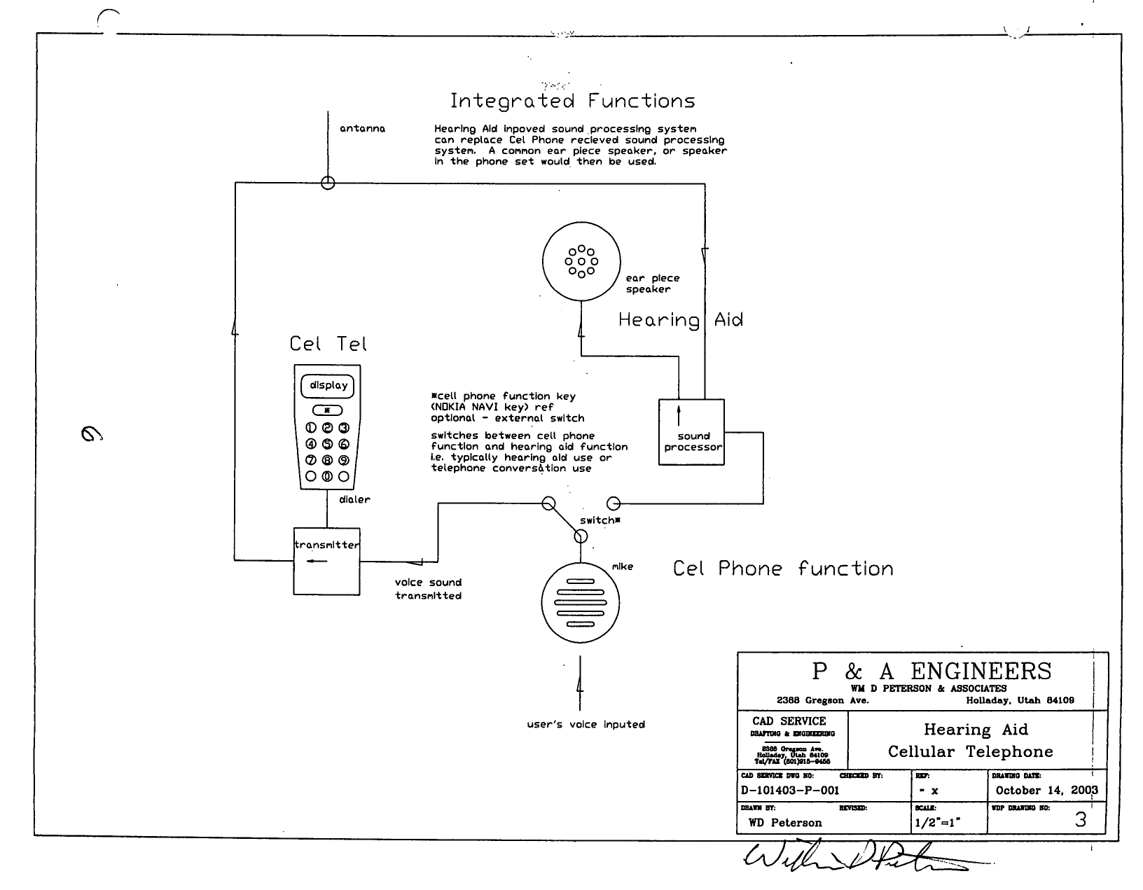

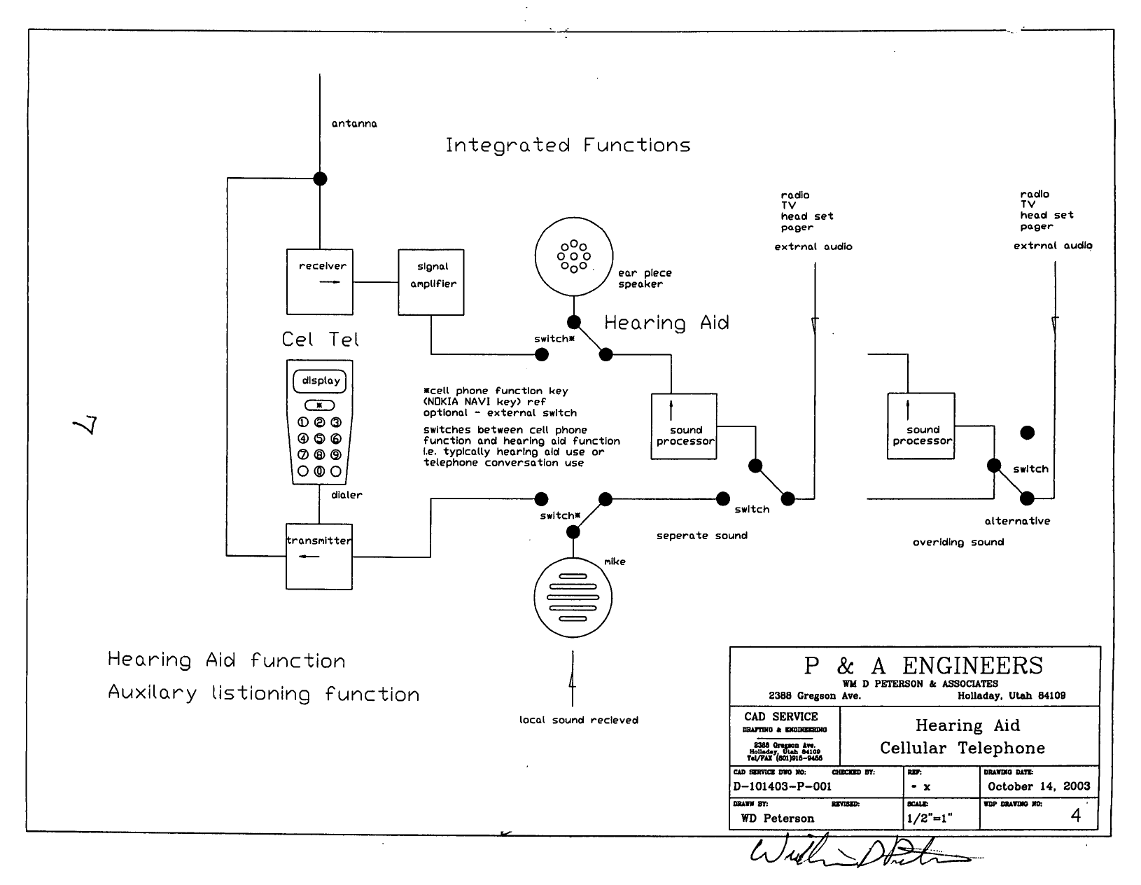

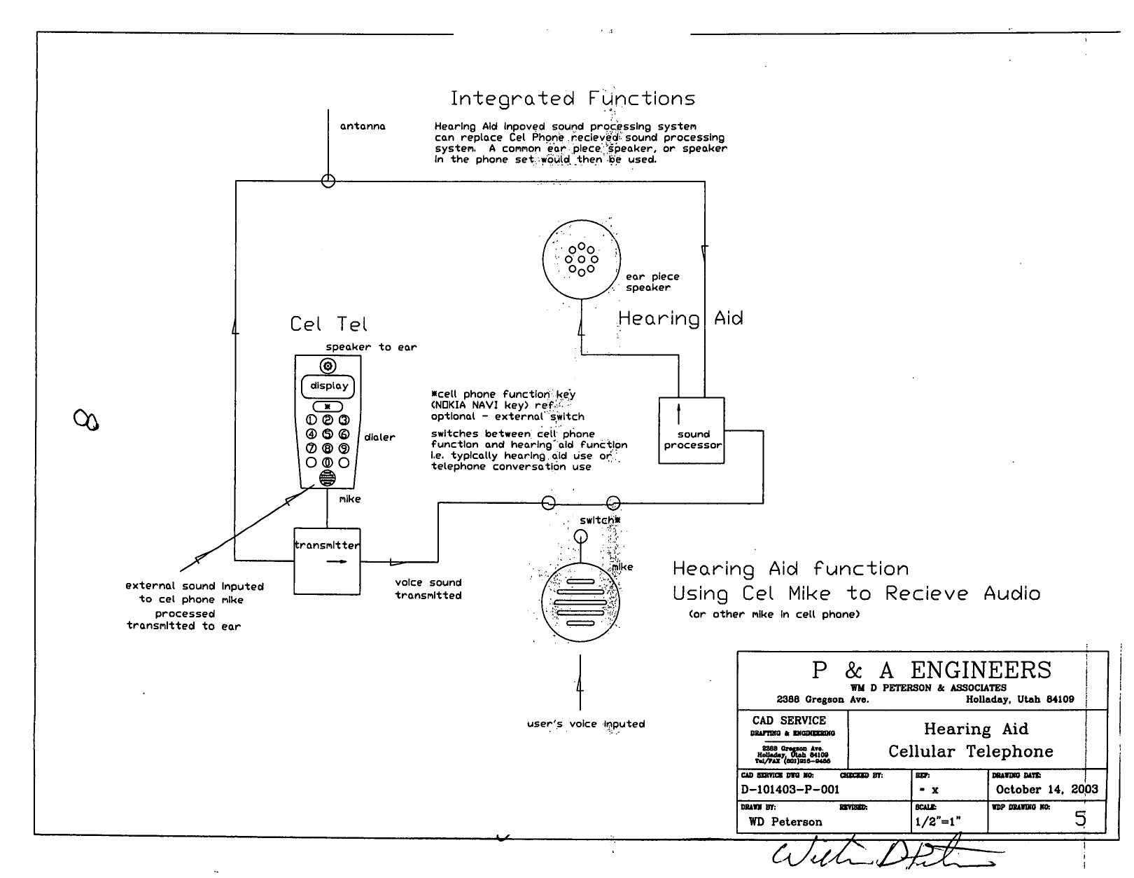

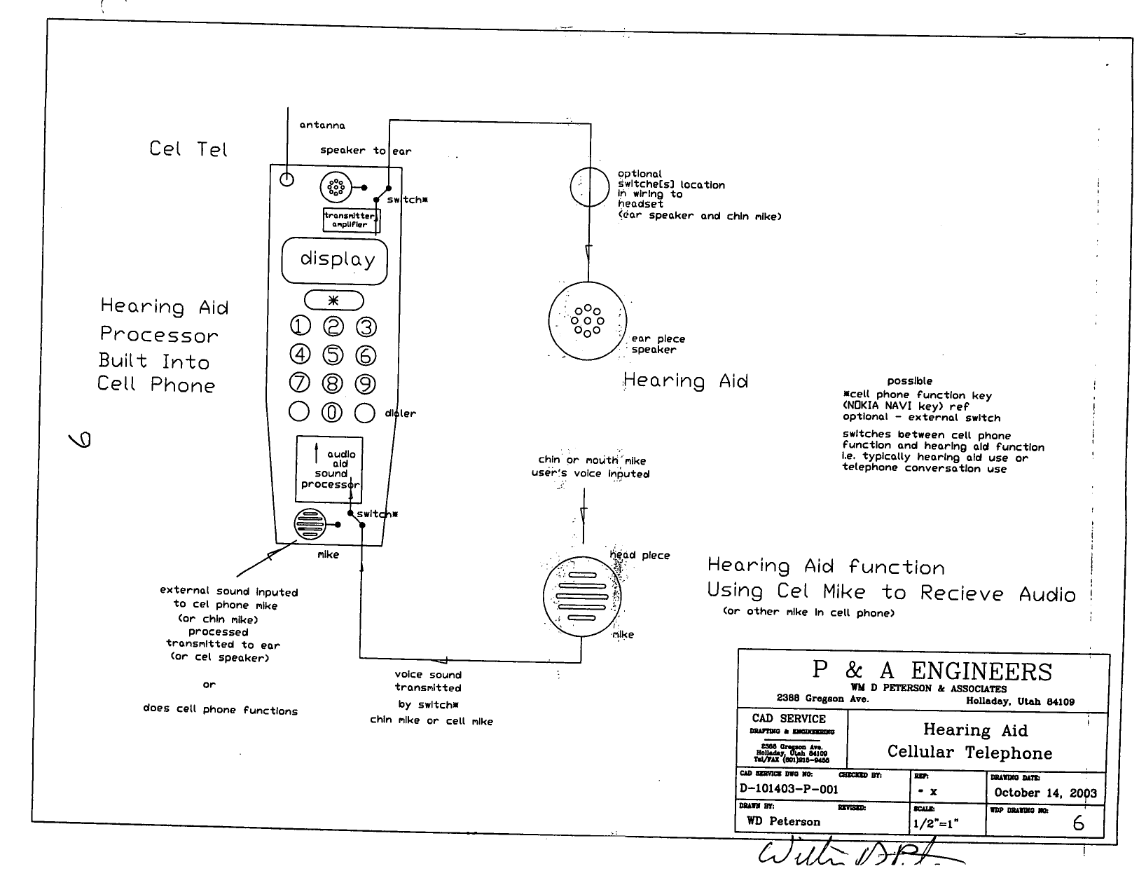

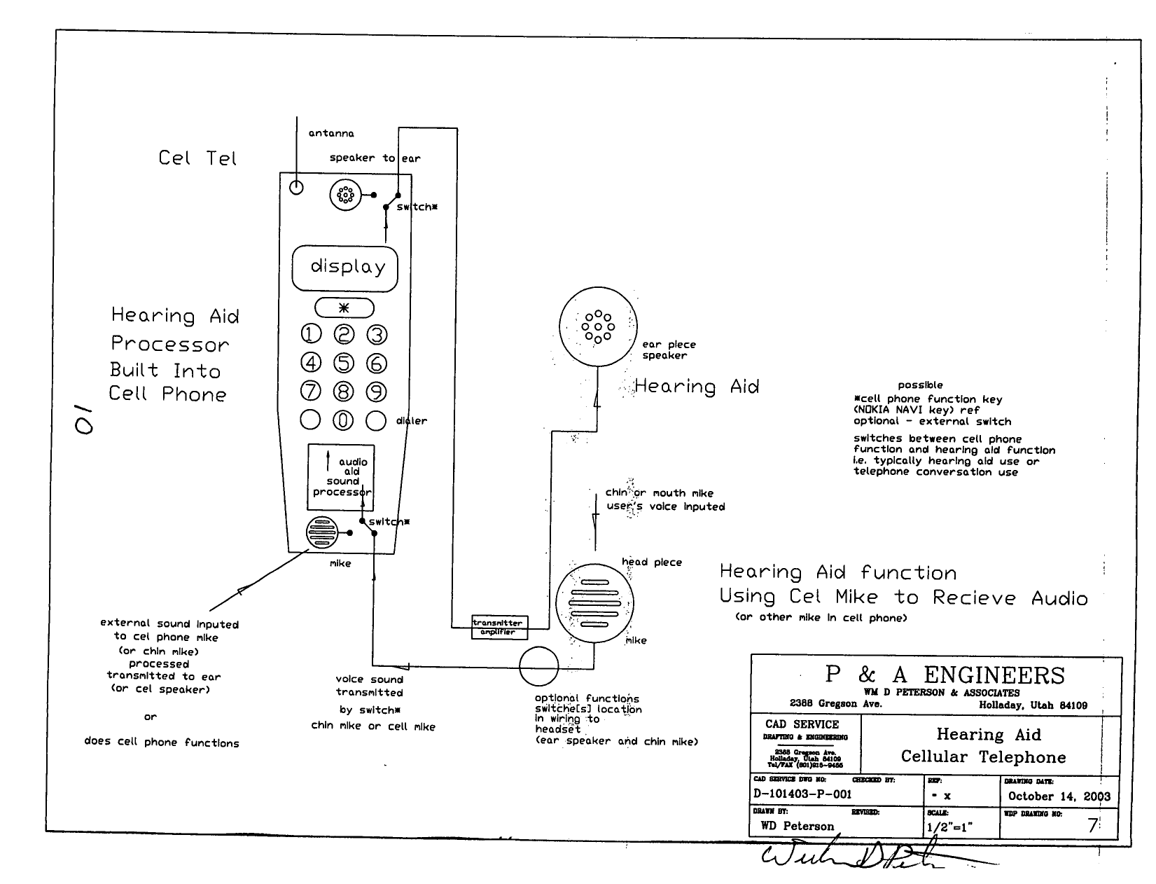

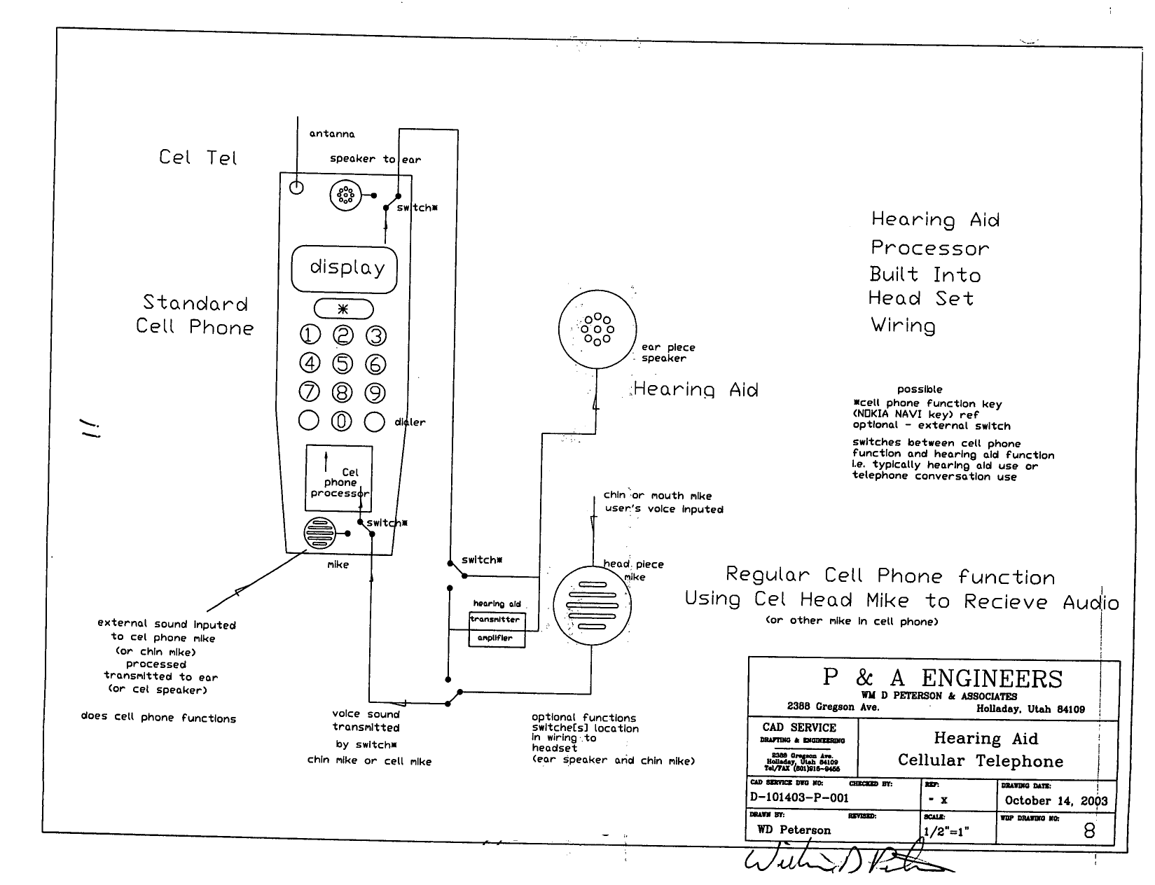

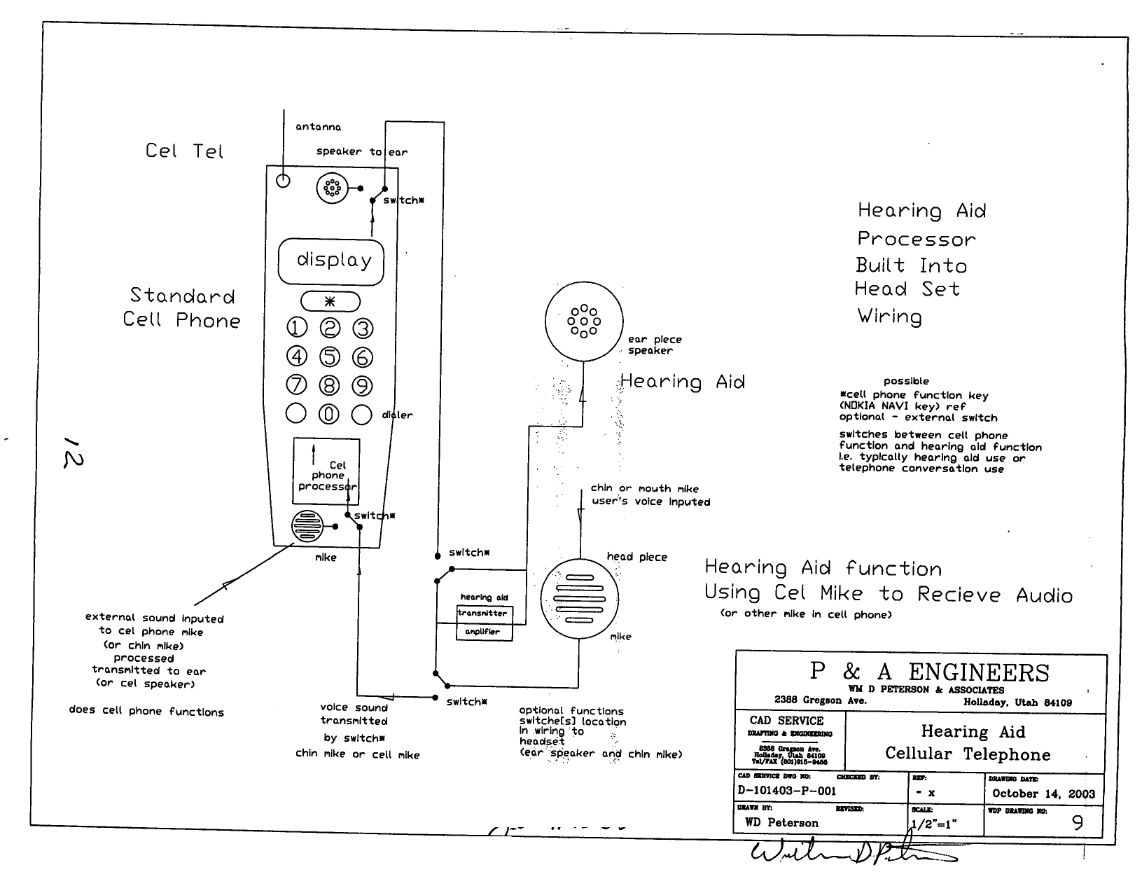

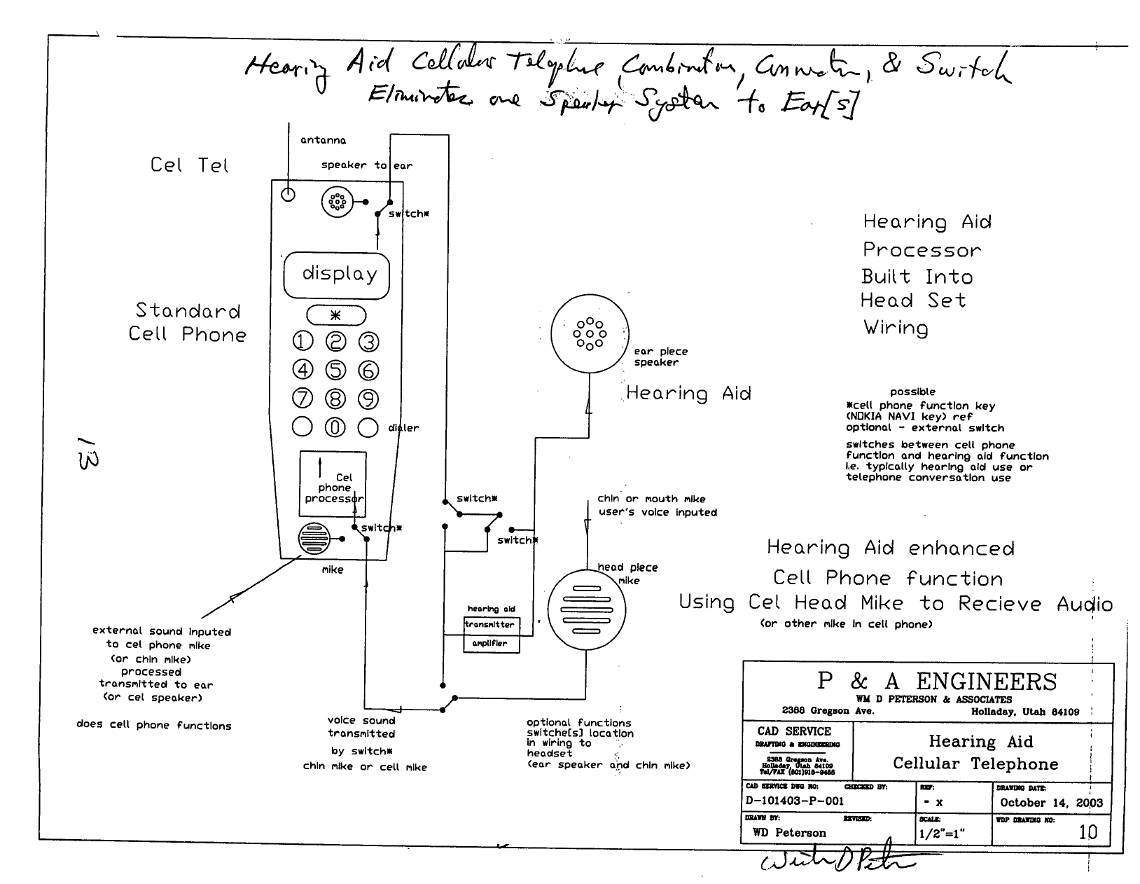

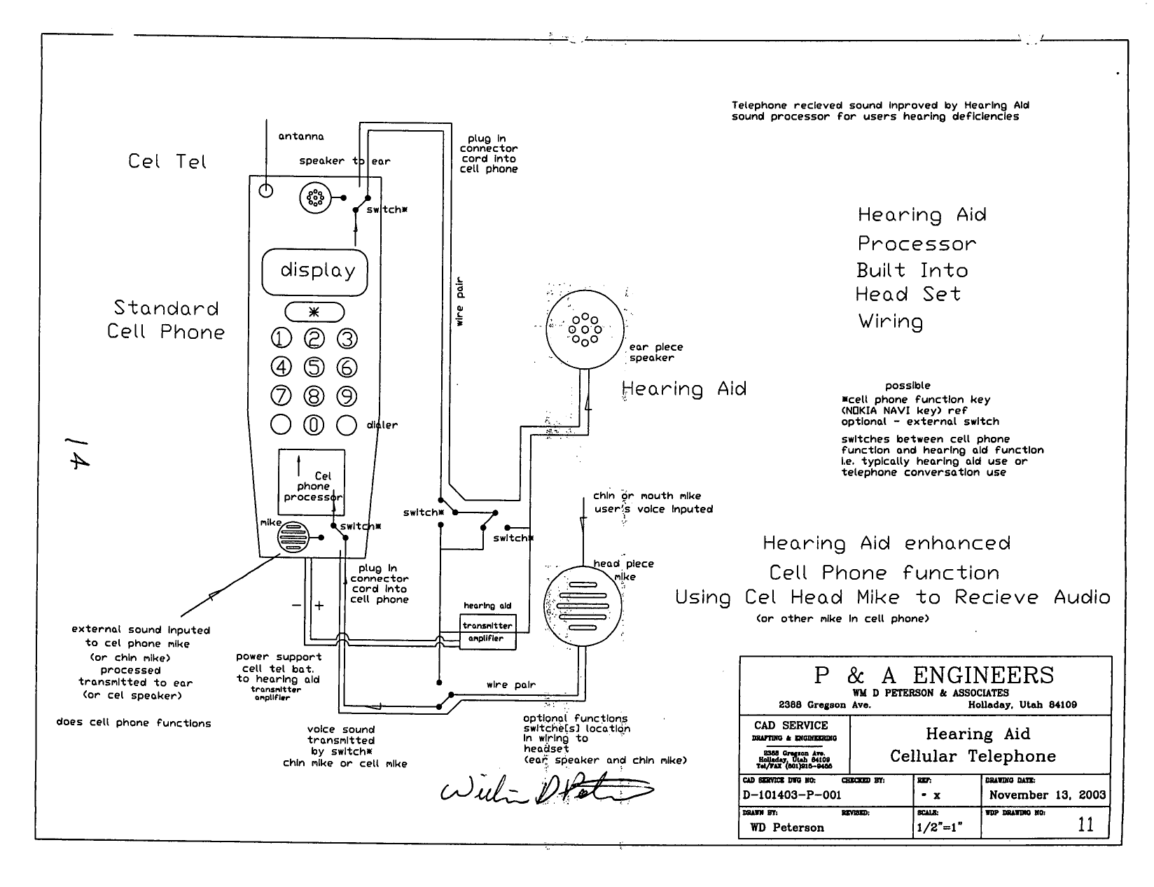

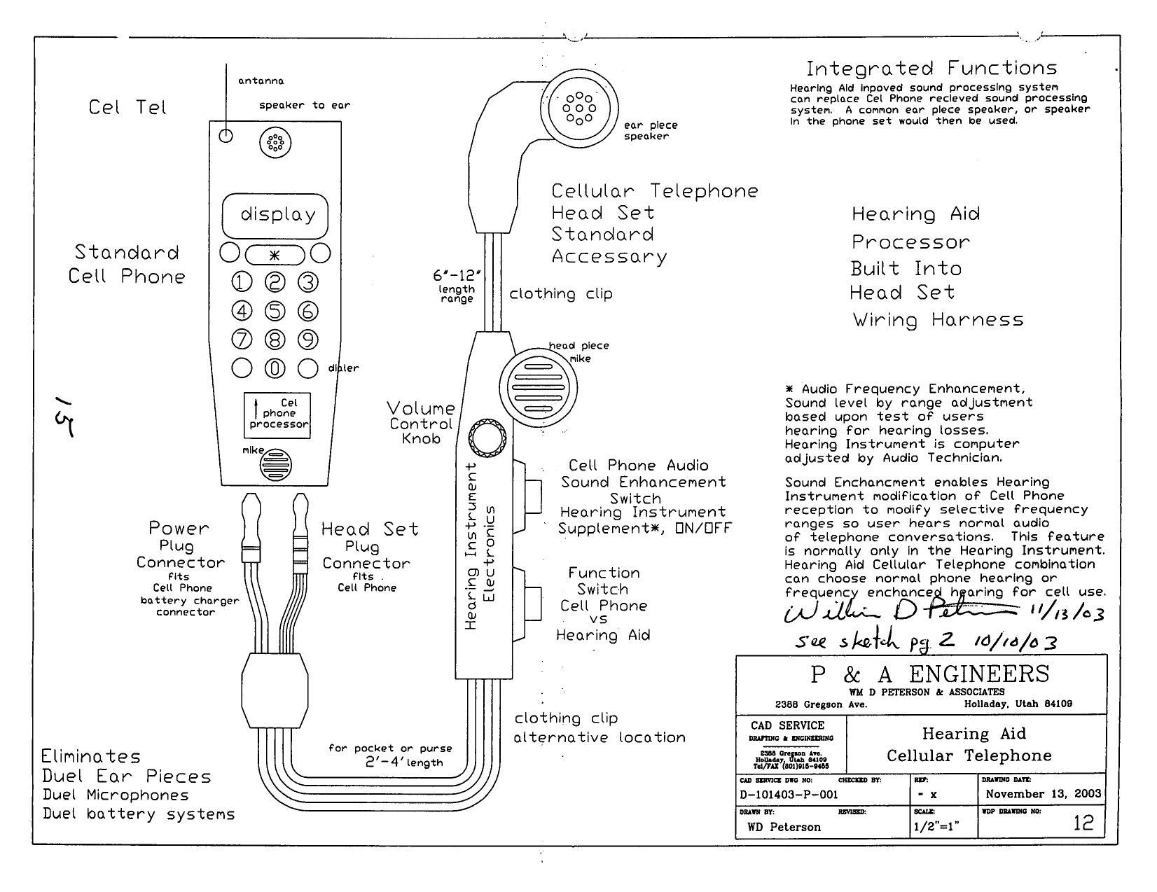

### DETAILED DESCRIPTION OF THE INVENTION

To improve communication 1 to a “the” person 2, from another 3, three communication devices 4 are combined into one integrated unit 6, hearing aid 7 electronics 8, a cellular telephone 9 (CelTel), and a message recorder and player 11, both local audio 12 (voice 13) sound 14 and electronic 16 messaging (cellular 17) telephone 9, recorded sounds 18 are put through the hearing aid 7 electronics 8 to prepare the sound 18 frequencies 19 for the deficiencies 21 of “the” person 2 using the system 6. Listening selection 22 between local voice 13 sounds and instrument sounds (cellular phone—CelTel, or other electronics) 16 are made automatically or activated with switches 23. The normal listening mode would be local (voice 13). When communicating by phone 3 the normal listening mode would be voice to voice via electronics 16. But the speaking 1 out of “the” person 2 would always be communicate out to both local and phone, so one listening mode option would be the same, hearing all 26.

Then a telephone silent communication (TSC) option 27 of the system allows the person 2 to listen to the voice of the incoming caller, but instead of responding vocally “the” person responds with a selected recording 28. The conversation 29 continues this way so to communicate by phone without intrusion or disruption 29 with any other person 3 or circumstances about the presence of “the” communicating person 2. Phone ringing 31 can be done with vibration 32, not sound. To feel the vibration 32, the CelTel 9 would best be in a shirt pocket 33, or for a lady maybe worn as a necklace 34, or on a waist band, inside a jacket pocket 36 that contacts the body 37 would work, clipped to and hanging from a belt 38 might not transfer the vibration as well. Otherwise, phone ringing sound 39 would need to be limited to sound through “the” person's earpiece 41. This makes for communication 1 by a person 2 with someone 3 outside without disruption 42 with inside persons 3.

So the system 6 has all sounds to “the” person 2 coming in to either a hearing aid receiving speaker 28 or the cellular telephone receiver 29. In come cases, it might be better or simpler to have both sound sources coming into the cellular telephone 43. Sounds from either source 12 are put to the hearing aid electronics 6 so either sounds going to “the” person 2 are corrected to work with “the” person's hearing deficiencies 44. The cellular telephone has a rechargeable battery system 46 so for the normal mode of operation the power 46 for the hearing aid 7 and receiving speaker (Mic) 47 for the hearing aid 7 would be associated with the cellular telephone 9. i.e. be in the cellular telephone 9 module. But to make the hearing aid 7 usable without the cellular phone 9, a separate battery pack 48 and speaker 47 associated with the hearing aid 7 would be required.

In the TSC (Telephone Silent Communication) mode 27 there are a few standard answers 49 that will fit to respond to many phone calls. Other pat answers 51 can be programed into the unit 8 by the phone's using person 2. Some form of the following pat answers 51 will be initially programed into the cellular phone 9 for replays: Using special keys 52 or the normal numbered keys 53 as follows, the call Answering and 2 4 6 7 8 and 9 keys 54 could be used to make the following replies:

Call Answer—I'm listening, I can' talk, tell me your concerns, I will respond with a message 56
9—Y—Yes, Yes, _ _ minutes, 57
6—N—No, 58
7—S—Say that again, tell me more, 59
4—I—I will call you, 61
4—I _ _,—I will call you in _ _ minutes, 62
2—C—Call—will You please Call me back, 63
2—C _ _, —will You please Call me back in _ _ minutes, 64
8—T—There—I will be There, 66
8—T _ _,—I will be There in _ _ minutes. 67 Copyright claimed for these answers.

In the cases of using the 2 4 6 7 8 9 keys, a return, or possibly the # Key would, initiate the relay, anyway, however the phone is normally answered. If more keys are used, the second and more key would convey a time in minutes 69, like “830 ret” would be I will be there in 30 minutes.

There will be all sorts of situations 42 and other special instances where unit 6 will be useful, i.e. any situation where “the” person 2 cannot audibly speak out or communicate 42, anyplace where vocal output is not permitted 71, a classroom, courtroom, church, a public function, like a play or concert, most any sort of meeting where any deviant noise is disrupting; then, any situation where ambient noise makes “the” person's voice inaudible 72, such as a noisy vehicle—fire engine, any vehicle using a siren, loud engine noises, aircraft, truck, construction machinery; even, a physical disability to make sound 73, or inability to speak the language.

Most mode switching 74 and input will be done on the cellular phone keys 53. For convenience it may be more convenient to do basic mode switching 23 at the microphone 47, such as CelTel 9 vs hearing aid 7 mode 76, or answer 77, hang up 78, which could combine functions 79—cell & answer, hangup & switch back to hearing aid, and hearing volume 81. A phone call ringing 31 in might automatically switch 83 the phone 6 from hearing aid to cellular phone 9. Then a hang up might switch from phone 9 back to hearing aid 7. A switch would keep the use of the phone 6 in the TSC mode 76 or regular mode. Ringing 31 in would be silent 32 when the phone 6 is in the TSC mode 76.

Phone answering key—Hi, I am listening, talk to me, I'll respond
9—Y—Yes,
6—N—No,
7—S—Say that again, tell me more
4—I—I—I will call you,
4—I _ _,—I will call you in __ minutes,
2 —C—Call—will You please Call me back,
2—C _ _,—will You please Call me back in __ minutes,
8—T—There—I will be There,
8—T _ _,—I will be There in _ _ minutes.
   2 4 6 7 8 9

A reply or receiving messages is initiated with the phone key pad by inputting Y, N, I, C, T, I _ _, C _ _, T _ _, where the blanks _ are a telephone key pad inputted number representing minutes

Item Description Numbers Telephone Silent Conversing (TSC)

communication 1
“the” person 2
another 3
three communication devices 4
one integrated unit 6, 4?
hearing aid 7
electronics 8
cellular telephone, CelTel 9
message recorder and player 11
local audio 12, 14?
(voice 13)
sound 14
electronic 16, 8?
(cellular telephone messaging 17)
   messaging telephone 17
recorded sounds 18
   hearing aid 7
   electronics 8
   sound 18
frequencies 19
deficiencies 21
   “the” person 2
   the system 6.
Listening selection 22
   local voice sounds 12
   instrument sounds (cell phone or other electronics) 16
switches 23
switches for automatically selection 24
   normal listening mode would be local (voice) 13
   voice to voice 13 via electronics 16
   local 3
   phone 3
one listening mode option, hearing all 26
telephone silent communication (TSC) option 27
   allows the person to listen to the voice of the incoming caller, but instead of responding
   vocally “the” person responds with a 2
selected recording. 28
conversation 29
   continues this way so to communicate by phone without intrusion or disruption with 29
   any other person or circumstances about the presence of 3
   “the” communicating person 2
Phone ringing 31
vibration, not sound 32
shirt pocket 33
or for a lady maybe worn as a neckless 34
or on a waist band, inside a jacket pocket 36
that contacts the body would work 37
clipped to and hanging for a belt 38
sound phone ringing piece sound 39
earpiece “the” person's earpiece 41
   communication by a person 1
   someone outside 3
disruption, without 42
   inside persons 3
      The system 6
      all sounds to “the” person
   hearing aid receiving speaker 28
   cellular telephone receiver 29
both sound sources—coming into the cellular telephone 43
   Sounds from either source 12
   hearing aid electronics 6
“the” person's hearing deficiencies 44
rechargeable battery system so 46
   operation the power for the hearing aid 46
receiving microphone for the hearing aid 47
   would be associated with the cellular telephone 9
   i.e. be in the cellular telephone module 9
separate battery pack 48
   separate speaker (Mic.) associated with the hearing aid 47
   TSC (Telephone Silent Communication) mode 27
standard answers 49
Other pat answers can be programed into the unit 51
special keys 52
Call Answering key—automatic reply—Hi, I'm listening, talk, I'll give you an answer 53
numbered keys as follows, the 2 4 6 7 8 9 keys 54
   replies:
initial call—Answer—Hi, I'm listening, talk to me, can't talk, but I'll reply 56
   9—Y—Yes, 57
   6—N—No, 58
   7—S—Say that again, tell me more 59
   4—I—I—I will call you, 61
   4—I _ _,—I will call you in __ minutes, 62
   2—C—Call—will You please Call me back, 63
   2—C _ _,—will You please Call me back in __ minutes, 64
   8—T—There—I will be There, 66
   8—T _ _,—I will be There in _ _ minutes. 67
      Copyright
return (# key) used following the 2 4 6 7 8 9 keys 68
time in minutes, digits after function before # key 69
anyplace where vocal output is not permitted 71
ambient noise makes “the” person's voice inaudible 72
physical disabled to make sound 73
mode switching and input will be done on the cellular phone keys 74
   basic mode switching at the microphone 23
CelTel vs hearing aid mode (TSC) 76
answer 77
hang up 78
combine functions—cell & answer, hangup & switch back to hearing aid 79
hearing volume 81
automatically switch, hearing aid to cellular phone 82
automatic switch, a hang up might switch the from phone back to hearing aid 83
   TSC mode (silent ringing) or regular mode switch 76
      Telephone Silent Conversing (TSC)

1. A telephone system with means to answer an incoming call, having means for the receiving party to listen to the incoming calling party's voice and message, having pre-recorded messages for the receiving party to activate for an answer to the incoming message of the caller.

2. The system of claim 1 and further having the first and fundamental reply message saying: Hello, the party (person) (phone number) you called has answered, (I, or person's name, or someone) is listening, and will provide a response, so please talk to me.

3. The system of claim 2 and further having the receiving telephone having reply messages and means for the receiving party to choose, or select, and use to make his preferred reply message.

4. The system of claim 3 and further having the receiving telephone having means to write-in, store, and play back new and different reply messages.

5. The system of claim 4 and further having receiving reply messages would include, but not be limited to: Yes, No, Say that again, tell me more, I will call you, will you please Call me back, I will call you in __ minutes, Call me back in __ minutes, i will be There, i will be There in __ minutes. A reply or receiving messages is initiated with the phone key pad by inputting Y, N, I, S, C, T, I _ _, C _ _, T _ _, where the blanks _ are telephone pad inputted digits to convey time in minutes, like “5” five minutes, “15” fifteen minutes, “120” two hours. So to respond with a receiving message, the first digit (Y, N, S, I, C, T) is an answer, then one or more digits used would be time. Note, in a phone key pad Y is 9, N is 6, S is 7, I is 4, C is 2, and T is 8. Example, 415 inputted would make the reply message “I will call you back in fifteen minutes. The other numbers 1, 3, 5, and 0 and combinations are digits that can be used for other messages.

6. The systems of the claims above having a mode switch to change from off to regular phone operation and to silent receiving phone mode.

7. The system of claim 3 and further having an ear speaker wired from the phone and phone have switches so that the person receiving phone calls can discreetly access the phone and its key pad and select an answering (or sending) switch and discretely select reply message selection switches, which switches may be the standard configured cel-phone switches, or special switches especially configured so they may be discreetly accessed even without visually looking at the phone.

8. The system of claim 7 and having a hearing aid sound amplifier wired between the phone and the ear speaker, a switch to select the source of the sound being sent to the ear, local ambient sound or telephone messaging sound, or both. The hearing aid amplifier and switching being separate and independent between the phone and speaker, or being mounted in or with the phone or the ear speaker.

9. The system of claim 7 and further having a pair of ear speakers, a speaker for each ear so the listener can hear stereo.

10. The system of claim 9 and further having a radio and or media player and switches so the user can listen to radio broadcasts or recordings in leu of, or in addition to phone calls or ambient sounds, including vocal conversation.

11. The above claims where the TSC is configured so a phone call can be and is initiated and conducted by use of the TSC device, silently, without the caller using his voice.

12. The above claims where the TSC system uses either a Cellular Telephone, or a conventional hard wired telephone.
